(19) United States
(12) Patent Application Publication
(10) Pub. No.: US 2008/0309184 A1
(43) Pub. Date: Dec. 18, 2008

(54) Support device for supporting a rotor for rotation

(75) Inventors: Martin Eilers, Asslar (DE); Mirko Mekota, Ehringshausen (DE)

Correspondence Address: ABELMAN, FRAYNE & SCHWAB, 666 THIRD AVENUE, 10TH FLOOR, NEW YORK, NY, 10017, US

(73) Assignee: Pfeiffer Vacuum GmbH

(21) Appl. No.: 12/150,280

(22) Filed: Apr. 24, 2008

(30) Foreign Application Priority Data
Apr. 26, 2007 (DE) 10 2007 019 667.0

(51) Int. Cl. H02K 7/09; F16C 19/08; F01D 1/36

(52) U.S. Cl. 310/90.5; 384/490; 415/90

(57) ABSTRACT

A support device for rotatably supporting a rotor (1) and including a support rotor (2; 2′) connectable with the rotor (1); a support stator (3; 3′) and a connection element (5; 5′) displaceably supported in a housing portion (4a, 4b) of the support device and connected with the support stator (3; 3′), with the connection element (5; 5′) and the housing portion (4a, 4b) having each a flat surface (11; 10), and with the flat surfaces (11; 10) being located opposite each other and extending parallel to each other.

### BACKGROUND OF THE INVENTION

1. Field of the Invention

The present invention relates to a support device for rotatably supporting a rotor and including a support rotor connectable with the rotor, a support stator, a housing portion, and a connection element displaceably supported in the housing portion and connected with the support stator. The present invention also relates to a turbomolecular pump with the inventive support device.

2. Description of the Prior Art

In many systems, there are provided different devices for supporting a rapidly rotating rotor. In particular, such rotors are used in vacuum pumps which function on the principle of gas friction. Vibrations, which occur in such systems, cause certain problems.

Firstly, these vibrations are induced by a pumping action, e.g., due to excitation of natural frequencies which both the rotor and their supports have. In particular, when the rotational speed of the rotor changes, the natural frequencies are excited as a result of unpreventable imbalance of the rotor. On the other hand, these pumps are subjected to vibrations because of their surroundings and the mounting conditions. These vibrations should be kept away from the rotor. The task consists in decoupling of the pump housing from the rotor in order to suppress the transfer of vibration thereto.

European Publication EP-A 0 867 627 discloses a damping system for magnetically supported rotors and having an intermediate element arranged between the housing and the rotor and supported against the housing by balls. The balls are displaced in caps. The drawback of the disclosed arrangement consists in that independent of the used material and the cap radius, a smallest deviation of balls generates large restoring forces. The basis for it consists in that the selection of the ball and cap materials is limited by forces acting in the pump, e.g., the weight of the rotor or support forces in the permanent magnet bearings which act along the rotor axis. Finally, the desired function is not achieved.

Accordingly, an object of the invention is to provide a support device for a rotatable rotor and which increases consistency of the vibration, permitting to take into account forces acting on the rotor.

### SUMMARY OF THE INVENTION

This and other objects of the present invention, which will become apparent hereinafter, are achieved by providing a support device of the type discussed above and in which the connection element and the housing portion have each a flat surface, with the flat surfaces of the connection element and the housing portion being located opposite each other and extending parallel to each other.

The flat, parallel to each other and located opposite each other, surfaces of the connection element and the housing portion insure that the connection element is rigidly supported in the direction substantially parallel to the rotational axis of the rotor, but the stiffness of the connection element in the direction transverse to the rotational axis of the rotor is small. Thereby, it is insured that the rotor can freely pivot in the direction transverse to its axis, while no deviation takes place in the axial direction. Thereby, a very high consistency with respect to the axial force components is achieved, which are generated, e.g., by the weight of the rotor, support forces, or flow forces produced during pumping process.

In the simplest case, the surfaces form part of a sliding support. The surfaces slide along one another, and the friction therebetween simultaneously provides for damping of the movement of the connection element relative to the housing portion. The friction can be provided by a suitable selection of the material pairs for the connection element and the housing portion. It is also possible to provide one or more surfaces with a coating to thereby influence the friction.

According to further development of the invention, a ball is provided between the flat surfaces. The ball reduces the friction and diminishes the requirement to the surfaces.

According to the advantageous embodiment of the invention, there are provided two rows of balls, with the balls of each row being arranged between parallel flat surfaces of the housing portion and the connection element. This insures a symmetrical construction that provides for force action in opposite directions, e.g., in both, opposite direction of the rotor axis.

A compact construction is achieved when two planes that pass through ball centers of the two rows of balls, respectively, are spaced from each other by a distance smaller than a ball diameter.

According to a further advantageous embodiment of the present invention, a damping member is provided between the connection element and the housing portion. Thereby, in a simple manner, centering of the connection element relative to the housing and damping of its movement is achieved.

According to a particular embodiment of the present invention, the damping member contains an elastomeric material subjectable to shear or pressure forces. This increases the range of usable materials and, therefore, of usable damping characteristics. Thereby, a support device with very specific characteristics can be produced.

According to further development of the present invention, the damping member is so formed of a material that it has a progressive spring characteristic. This means that with an increased deviation of the rotor from a nil position, an overproportionally increasing restoring force that provides for return of the rotor in its nil position is achieved. The restoring forces are large only at large deviations, at small deviations, the restoring force is small, and the transmission of vibrations between the rotor and the housing remains small.

The further development of the present invention is based on the type of a bearing support that the connection element insures. The support rotor and the support stator contain permanent magnets and form together a permanent magnet bearing. Such bearings produce, at a smallest axial deviation from the nil position, forces in the axial direction, whereby a high axial stiffness of the support device according to the present invention becomes particularly advantageous.

According to further development of the present invention the support rotor and the support stator form rings of a rolling bearing. Rolling bearings transmit vibrations directly. In addition, the vibration affects or cause wear of the bearing. Therefore, the properties of the inventive support device are particularly usable in this case.

According to further development of the present invention, a stop is provided in the housing portion for limiting displacement of the connection element in a direction parallel to the flat surfaces of the connection element and the housing portion. Thereby, in a simple manner, it is possible to prevent contact between rotatable and stationary components which can lead to uncontrolled release of a portion of the enormous rotational energy. The rotatable components in this case are the support rotor or, in case of a turbomolecular pump, its rotatable blade discs.

The properties of the inventive support device are particularly usable in a vacuum pump because in this pump and, in particular, in its high vacuum region, high, specific demands are made to the chemical stability of the material subjected to the gas action. This demand can be met particularly easy with an inventive support device.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a cross-sectional view of a first embodiment of a support device according to the present invention;

FIG. 2 a cross-sectional view of a second embodiment of a support device according to the present invention;

FIG. 3 a cross-sectional view illustrating modification of a support device according to the second embodiment; and

FIG. 4 a cross-sectional view of a turbomolecular pump with support devices according to the present invention.

### DETAILED DESCRIPTION OF THE PREFERRED EMBODIMENTS

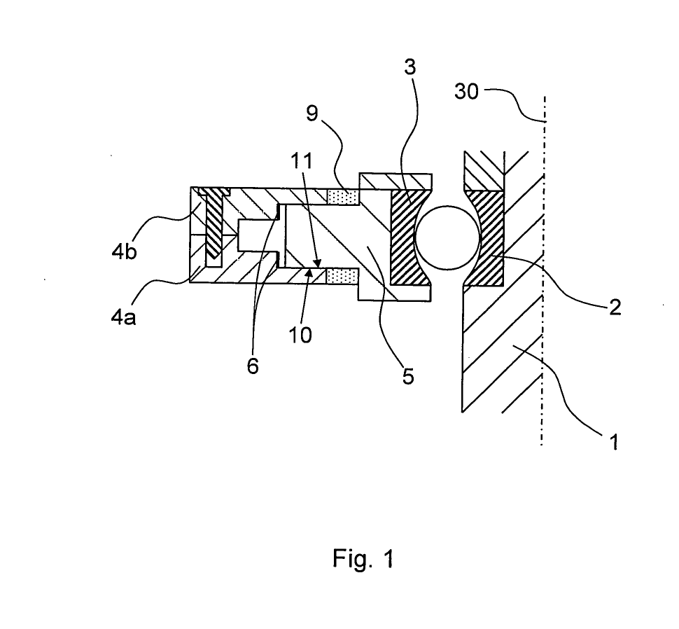

A support device according to the present invention, a first embodiment of which is shown in FIG. 1, includes a support rotor 2 arranged on a rotor 1 that defines a rotational axis 30. In the embodiment shown in FIG. 1, the support rotor 2 is formed as an inner ring of a ball bearing. A two-part housing portion 4a, 4b serves for supporting the support rotor 2. A connection element 5 is provided between the housing portion 4a, 4b and the support rotor 2. The connection element 5 is connected with a support stator 3 that is formed as an outer ring of a ball bearing in the embodiment shown in FIG. 1. A damping member 9 is provided between the connection element 5 and the housing portion 4a, 4b. The damping member 9 is subjected to a pressure load. The damping member 9 can be formed as an elastomeric part with a circular cross-section or, in particular, as a toroidal ring, which provides for an advantageous progressive spring characteristic of the restoring force. Alternatively, the bearing surface of an elastomeric ring can have a rectangular cross-section with a curvature. With both types, it is insured that the contact zone between the bearing surface and the ring is increased at deformation, providing a progressive spring characteristic. The elastomeric materials have advantageous characteristics of becoming harder at increasing high frequencies. Therefore, these materials influence the vibration characteristics or behavior only in a desired region of lower frequencies, in particular in a region of natural frequencies of a magnet bearing. The housing portion 4a, 4b and the connection element have parallel opposite flat surfaces 10 and 11. In the embodiment shown in FIG. 1, the surfaces 10 and 11 contact each other, whereby they can slide over each other in a direction transverse to the rotational axis 30, i.e., radially. To provide for the sliding support, a suitable material pairing for the components or housing parts 4a, 4b and the connection element 5 is selected, or the flat surfaces 4a, 4b are suitably coated. As a coating, polytetrafluoroethylene-containing coating, e.g., can be used. The sliding movement between the connection element 5 and the housing portion 4a, 4b is limited by a stop 6.

The stop 6 is formed by surfaces extending parallel to the rotational axis. The parallelity of the surfaces 10 and 11 provides for a play-free assembly and a high tilting resistance, i.e., the connection element 5 cannot tilt in directions for surface normals of surfaces 10 and 11.

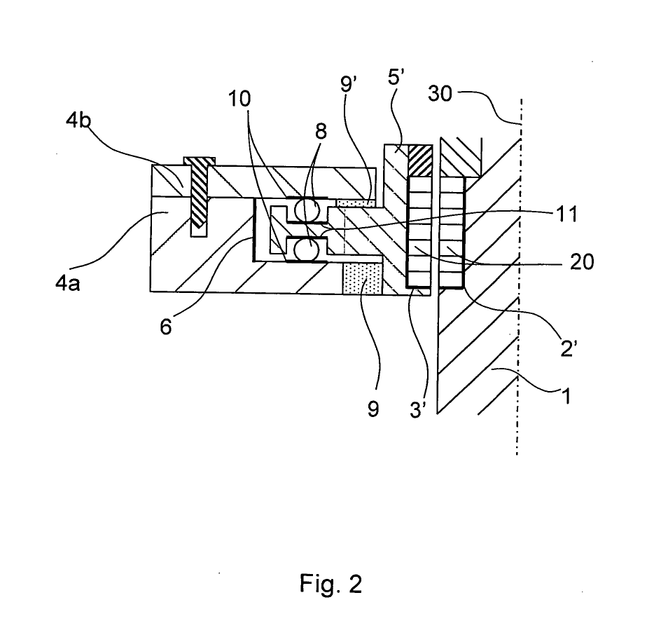

A second embodiment of a support device according to the present invention is shown in FIG. 2. In this embodiment permanent magnets 20 are provided on a connection element 5′ and the rotor 1. The totality of magnets 20 on the rotor 1 forms a support rotor 2′, and the totality of the magnets 20 on the connection element 5′ forms a support stator 3′. Spacers can be provided between separate magnets 20. The support stator 3′ and the support rotor 2′ form together a permanent magnet bearing a two-part housing portion 4a, 4b has a stop 6 that limits radial movement of the connection element 5′. The housing parts 4a, 4b can be connected with each other by screws, as shown in FIG. 2. The two housing parts can also be connected by soldering, laser welding, gluing, etc. The connection element 5′ and the housing portion 4a, 4b have parallel flat surfaces 10 and 11, respectively, between which, e.g., a ball 8 can be provided. The ball 8 provides, at an almost continuous greater axial stiffness, for a very small friction that acts contrary to the radial movement of the connection element 5′. With three balls being provided between each surface pair 10, 11, an optimal definition is achieved.

This means that a play-free assembly is possible, and in summary, a high stiffness of the arrangement of the connection element 5′ against tilting relative to the housing portion is achieved. The radial movement of the connection element 5′ is damped by damping members. In addition, the damping members provide for centering of the connection element 5′ in the housing portion. The first damping member 9 is subjected to pressure, whereas the second damping member 9′ is subjected to shearing stresses at a shearing load applied to a damping member. Progressive spring characteristics can, e.g., be achieved by using inhomogeneous material or a laminate of several layers with, respectively, different deformation characteristics. A radial stiffness of the support of the connection element in a housing portion, which is provided by balls, is much smaller than that of the magnet bearing. At the same time, the axial stiffness of the connection element 5′ is much greater than that of the magnetic bearing. This insures an optimal arrangement of the support rotor 2′ and the support stator 3′ relative to each other, insuring an optimal functioning of the bearing under action of axial forces on the rotor. The flat surfaces 10, 11 extend transverse to the rotational axis. However, the surfaces 10, 11 can also be inclined to the rotational axis. In order to keep the overlapping of radial and axial movements small, the inclination angle of the surfaces 10, 11 to the rotational axis is selected so that it is not two large.

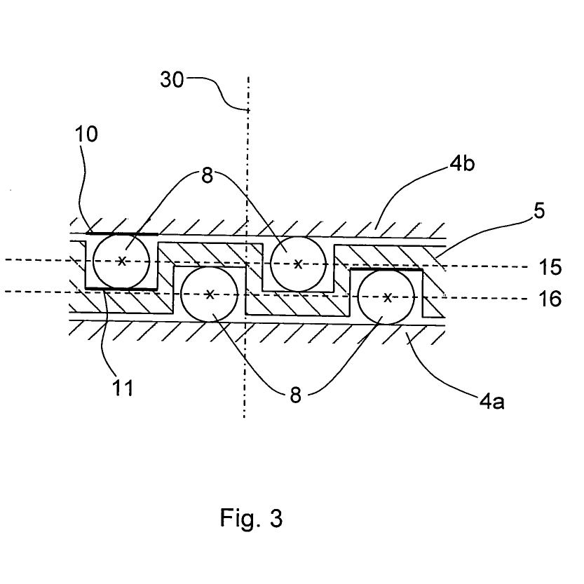

A modification of the embodiment shown in FIG. 2, is shown in FIG. 3. FIG. 3 shows arrangement of the connection element and the housing portion at the same distance to the rotational axis 30 and the arrangement of balls. There are provided two rows of balls 8, with each ball 8 being located in a pot-shaped recess that limits the movement of the bearing along the circumference and radius. In the axial direction, the balls 8 move toward each other along parallel to each other flat surfaces. The surface 10 is provided in the housing portion 4a, 4b. The surfaces 11 form an opposite end surfaces of the pots. In each row of balls, a flat plane passes through ball centers, with the plane 15 of the first row and the plane 16 of the second row being spaced from each other by less than the ball diameter.

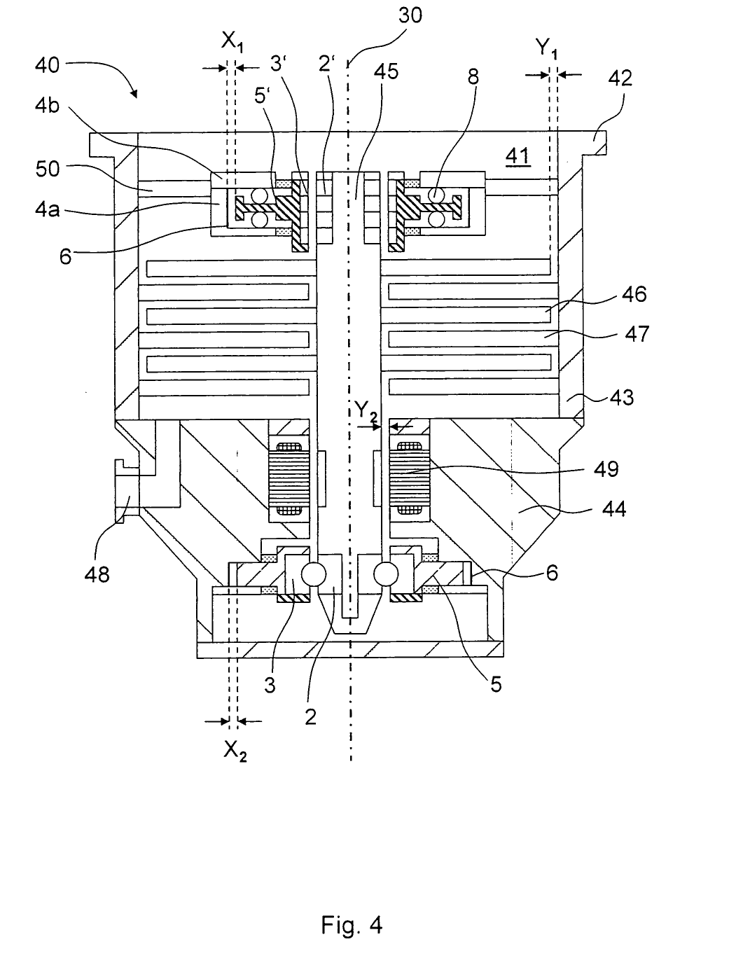

FIG. 4 shows a turbomolecular vacuum pump 40 having, at its high vacuum side, a gas inlet 41 and a flange 42 with which the pump 40 is releasably connected with a recipient, not shown. The turbomolecular vacuum pump 40 has further an upper housing portion 43 and a lower housing portion 44. A shaft 45 carrier's rotor discs 46 provided with blades. Stationary blades are provided on stator discs 47 which alternate with rotor discs in the axial direction. The rotor, which is formed of the shaft 45 and the rotor discs 46 is rapidly rotated by a drive 49. The compressed gas is expelled through a gas outlet 48.

A support 50 is connected with an adjacent to the rotational axis 30, inner side of the upper housing part 43 and the housing parts 4a, 4b of the support device. According to an advantageous embodiment, the upper housing part 43 of the pump 40, the support 50, and at least one of the housing parts 4a, 4b of the support device are formed integrally with each other as a one-piece member. The support 50 is so formed that the gas flow between the gas inlet 41 and the rotor disc 46 is possible.

An end of the shaft 45 remote from the gas inlet 41 is supported by a support device provided with a ball bearing. This support device corresponds to the support device shown in FIG. 1 but in which instead of the housing parts 4a, 4b, the lower housing part 44 of the pump 40 is so formed that it forms, together with the connection element 5, a slide support.

The support device provided at a shaft end adjacent to the gas inlet 41 corresponds to the support device according to the second embodiment which is shown in FIG. 2. Here, a support rotor 2′, which is equipped with permanent magnets, is arranged on the shaft 45. Opposite the support rotor 2′, a support stator 3′ likewise equipped with permanent magnets and mounted on the connection element 5′, is located.

FIG. 4 shows the advantages of the stop 6 of the support device shown in FIGS. 1-2. With the rotor not deviating from its central position, the distance between the connection element 5′ and the stop 6 in the upper support device amounts to X₁ and between the connection element 5 and the stop 6 in the lower support device—to X₂. Between the shaft 45 and the lower housing part 44, the clearance amounts to ½, and between the upper housing part 43 and the rotor disc 46, the clearance amounts to Y₁. The stop 6 limits the deviation of the control element 5, 5′ in the radial direction. The support devices are advantageously so formed that X₁ and X₂ provide for a maximal radial deviation of the rotor at which the rotor discs 46 or the rotor shaft 45 do not contact housing parts 43, 44. This is achieved with X₁, X₂ being smaller than Y₁, Y₂, respectively.

The advantage of the support devices of the turbomolecular vacuum pump shown in FIG. 4 consists in that the axial forces, which are generated by permanent magnets, are absorbed by the support devices, while simultaneously, a radial freedom of motion provides for a substantially vibration-free running of the rotor. Shocks, which can be applied from outside do not act directly on the rotor but are insulated and damped by the support devices. This enables a noticeably grafe external excitations before a damaging contact or breakdown of the rotor occurs.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A support device for rotatably supporting a rotor (1), comprising a support rotor (2; 2′) connectable with the rotor (1); a support stator (3; 3′); a housing portion (4a, 4b) and a connection element (5; 5′) displaceably supported in the housing portion (4a, 4b) and connected with the support stator (3; 3′), the connection element (5; 5′) and the housing portion (4a, 4b) having each a flat surface (11; 10), the flat surfaces (11; 10) of the connection element (5; 5′) and the housing portion (4a, 4b) being located opposite each other and extending parallel to each other.

2. A support device according to claim 1, wherein the flat surfaces (11, 10) of the connection element (5; 5′) and the housing portion (4a; 4b) form parts of a sliding support.

3. A support device according to claim 1, wherein at least one ball (8) is arranged between the flat surfaces (11, 10) of the connection element (5; 5′) and the housing portion (4a; 4b).

4. A support device according to claim 3, wherein there are provided a plurality of balls (8) arranged in two rows for displacement of the connection element (5; 5′) relative to the housing portion (4a, 4b) in opposite directions.

5. A support device according to claim 4, two planes (15, 16) passing through ball centers of the two rows, respectively, are spaced from each other by a distance smaller than a ball diameter.

6. A support device according to claim 1, wherein at least one damping member (9) is located between the connection element (5; 5′) and the housing portion (4a, 4b) for centering the connection element (5; 5′) in the housing portion (4a, 4b) and for damping movement in a direction parallel to the flat surfaces (11; 10) of the connection element (5; 5′) and the housing portion (4a, 4b).

7. A support device according to claim 6, wherein the damping member (9) contains an elastomeric material.

8. A support device according to claim 6, wherein the damping member (9) is so formed that it has a progressive spring characteristic.

9. A support device according to claim 1, wherein the support rotor (2′) and the support stator (3′) contain permanent magnets (20) and form together a magnetic bearing.

10. A support device according to claim 1, wherein the support rotor (2) and the support stator (3) form rings of a ball bearing.

11. A support device according to claim 1, further comprising a stop (6) provided in the housing portion (4a, 4b) for limiting displacement of the connection element (5, 5′) in a direction parallel to the flat surfaces (11; 10) of the connection element (5; 5′) and the housing portion (4a, 4b).

12. A turbomolecular pump (40), comprising a shaft (45); a plurality of rotor discs (46) provided with blades and supported on the shaft (45); and means for supporting the shaft (45) for rotation and including a support device provided at least at one end of the shaft (45) and including a support rotor (2; 2′) connectable with the rotor (1); a support stator (3; 3′); a housing portion (4a, 4b); a connection element (5; 5′) displaceably supported in the housing portion (4a, 4b) and connected with the support stator (3; 3′), the connection element (5; 5′) and the housing portion (4a, 4b) having each a flat surface (11; 10), the flat surfaces (11; 10) of the connection element (5; 5′) and the housing portion (4a, 4b) being located opposite each other and extending parallel to each other.
